(19) United States
(12) Patent Application Publication
(10) Pub. No.: US 2025/0114859 A1
(43) Pub. Date: Apr. 10, 2025

(54) Method for determining a position of a workpiece in a processing chamber of a laser plotter for cutting, engraving, marking and/or lettering the workpiece, and method for calibrating and laser plotter therefor

(71) Applicant: Trotec Laser GmbH, Marchtrenk (AT)

(72) Inventor: Paul HAGER, Bad Wimsbach (AT)

(21) Appl. No.: 18/694,789

(22) PCT Filed: Sep. 27, 2022
(86) PCT No.: PCT/AT2022/060329

§ 371 Date: Mar. 22, 2024

(30) Foreign Application Priority Data
Sep. 30, 2021 (AT) A 50776/2021

(51) Int. Cl. B23K 26/03; B23K 26/046; B23K 26/364; B23K 26/38

(52) U.S. Cl. CPC B23K 26/032; B23K 26/046; B23K 26/364; B23K 26/38

(57) ABSTRACT

The present disclosure relates to a laser plotter and a method for calibrating as well as a method for determining a position of a workpiece in a processing chamber of a laser plotter for cutting, engraving, marking and/or lettering the workpiece. At least one beam source in the form of a laser is used in a housing of the laser plotter, whereby the workpiece is placed on a processing table and the position of at least one inserted workpiece on the processing table or in the processing chamber is detected via at least one camera. At least one camera for the processing chamber is integrated into a lid of the laser plotter, whereby detection of the position of the inserted workpiece or the processing chamber, such as the ruler, is performed both when the lid is open and when it is closed.

### TECHNICAL FIELD

The present disclosure relates to a method for determining a position of a workpiece in a processing chamber of a laser plotter for cutting, engraving, marking and/or lettering the workpiece, and to a laser plotter therefor.

### DESCRIPTION OF THE RELATED ART

Laser processing devices in which one or several laser sources are operated in alternating fashion are known from the prior art. Such laser devices include so-called laser plotters, which have an adjustable, belt-driven carriage on which a focusing unit is arranged also adjustably. Preferably, here flat workpieces such as paper, plates, textiles, ballpoint pens, cell phones, tablets, laptops, etc. are processed by a laser, in particular a laser beam, which is conveyed from the laser source via deflection elements to the focusing unit on the carriage and deflected by the focusing unit in the direction of the workpiece. Here, the laser plotter comprises a control unit to control and regulate all components. Usually, an external component, in particular a laptop, is used to create a graphic or text using commercially available or proprietary software, which is then transferred to the laser device, in particular its controller, in the form of a job. Certain parameters for processing the workpiece can be set on the same or another software program and integrated into the job. In order to be able to detect the workpiece inserted into the processing chamber of the laser plotter, one or several cameras are used in the newer models so that the workpiece is then shown on the display and/or the externally connected component, in particular a laptop. This makes it easy to set the starting point for the focusing unit. Furthermore it is possible to position several jobs, in particular the number of possible cutting patterns, on the workpiece.

For example, the “FUSION EDGE” laser plotter by Epilog (https://www.epiloglaser.de/Lasermaschinen/fusion-edge-laser-cutter-engraver/) has a camera system arranged on the lid of the laser plotter. This makes it possible to position graphics on the screen. Here, the camera system has a so-called “fisheye lens”, whereby the entire processing chamber can be recorded with the lid closed. In order for the camera system to work, a calibration process must first be carried out during initial commissioning by inserting a calibration element, preferably with symbols specially arranged on it, into the processing chamber so that calibration can then be carried out with the lid closed. After calibration, a workpiece that is imaged distorted by the camera lens is corrected accordingly so that the user can detect it on the screen without distortion. A disadvantage of the “Fusion Edge” is that the user must first insert the workpiece into the processing chamber, after which the lid of the laser plotter must be closed so that the camera system can take a picture of the inserted workpiece, which is then displayed on the screen of the connected component.

Furthermore, the company “Glowforge Inc” manufactures laser plotters with a camera system, as described for example in WO2018/98398 A1, in which a camera is arranged on the lid of the laser plotter and on the focusing unit. Here, too, a calibration process must be carried out during commissioning in order to rectify the optics used accordingly.

Another disadvantage of the Glowforge laser plotters is that the workpiece must first be inserted to determine the position and to record the workpiece, and the lid must then be closed to start the recording process.

At https://fablab-rothenburg.de/eine-kamera-fuer-unseren-lasercutter/, an application is described in which a webcam has been installed in a laser cutter, whereby this is arranged on the lid. In contrast to the other systems known from the art, this system can take a picture only when the lid is open.

### SUMMARY OF EMBODIMENTS

An objective of the present disclosure is to provide a method for determining a position of a workpiece in a processing chamber of a laser plotter for cutting, engraving, marking and/or lettering the workpiece, as well as a laser plotter for this purpose, in which on the one hand the above-mentioned disadvantages are avoided and on the other hand a high degree of user-friendliness for determining and positioning the workpiece is created.

The objective is achieved by the disclosed embodiments. Advantageous embodiments and/or process measures are described in the appended claims.

The objective of the present disclosure is achieved by a method for determining a position of a workpiece in a processing chamber of a laser plotter for cutting, engraving, marking and/or lettering the workpiece, in which at least one camera for the processing area is integrated in a lid of the laser plotter, whereby detection of the position of the inserted workpiece is carried out both with the lid open and with the lid closed, wherein automatic detection of the position, in particular of the opening angle of the lid, is carried out, whereupon a corresponding camera correction process is activated for the open or closed lid.

Here it is advantageous that it is now possible for the first time to perform a workpiece detection in two different positions or angles of the camera, respectively, whereby the position of the camera, i.e. whether the lid is closed or open, is automatically detected so that a camera correction process defined according to the position is carried out.

The option of using the camera system with the lid open or closed gives the user the significant advantage that positioning the workpiece in a defined working area on the processing table is simplified, as the user can insert the workpiece and check the position on the screen when the lid is open. If the workpiece is not within the defined range, rapid correction is possible, as it can be inserted and corrected with the lid open. This makes it easy to adjust the position several times until the workpiece is correctly positioned so that the lid can then be closed and the machining process started.

However, if a process is carried out in which the position of the workpiece can be arbitrary, the user can insert the workpiece, close the lid and then, for example, set the starting point on the displayed workpiece via the software and start the process.

Furthermore, the objective of the present disclosure is achieved by a method for calibrating the correlation of the image coordinates with the machine coordinates of a laser plotter for cutting, engraving, marking and/or lettering the workpiece (7), wherein, for the calibration process, an image is recorded by the camera of the processing chamber with an activated laser pointer, in particular a visible laser pointer point, and the image coordinates of the laser pointer, in particular of the laser pointer point, are determined via evaluation software.

The advantage here is that the evaluation of the image coordinates of the laser pointer, in particular the laser pointer point, achieves a high level of accuracy for the actual parameters. These can then easily be merged with the known machine coordinates. This makes it easy to generate specific correction parameters that can be used to display a recorded workpiece. Here, several successive workflows, in particular image recordings, can be carried out at different positions, which are linked to the respective machine coordinates in order to increase the accuracy for the rectification or correction, respectively, of a recorded image. Since in the laser plotter according to the present disclosure the image can be recorded both with the lid closed and with the lid open, it is necessary that the calibration process is also carried out with at least both positions of the lid with the laser pointer switched on in order to evaluate the image coordinates of the recorded laser pointer point.

Advantageous embodiments are also such in which a calibration process is carried out with the lid open and closed for the camera correction process, at least when the laser plotter is started up for the first time, by inserting a calibration object with calibration symbols arranged on it on the processing table. This ensures that the recorded image can be automatically corrected between the positions of the camera or the lid, respectively. The user is thus always presented an image/image sequence/video, especially with the same image size, regardless of whether the lid is open or closed. For the sake of completeness, it is pointed out that it is also possible to record the image in other positions of the lid, or that a corresponding correction is made depending on the lid position, i.e. that a correction of the image is made, for example, when the lid is opened or closed at any position of the lid.

However, advantageous embodiments are also such in which the opening and closing of the lid is detected by a switching element that sends a corresponding signal to the laser plotter control. This enables automatic switching of the correction process. This means that the user does not need to make any adjustments, regardless of whether the same wants to take the picture with the lid open or closed. This also makes it possible to quickly correct the position of the workpiece, as no settings need to be changed.

However, it is also pointed out that it is of course possible to deactivate the camera system in general or for individual positions in the application software, whereby preferably the latest setting is saved so that it can be used when reactivated. The system is deactivated, for example, if a movable protective lid for the camera at least partially covers its field of vision. Furthermore, it is possible that image recording is suppressed when the editing process is activated. However, it is also possible for the camera to remain switched on during the machining process on a workpiece and for the image/image sequence or video to be visible on the display or external component. This allows the machining process to be observed via the screen or the external component, respectively. For this purpose, it is also possible for the user to record and save the recorded images or video, respectively, for quality assurance purposes, which can optionally be easily activated via the user software, so that the external component, in particular the software running on it, or the laser plotter itself, saves the recording.

Advantageous embodiments are also such in which the position of the workpiece is displayed directly on a connected external component, in particular a laptop, or an integrated screen. This enables the user to see the workpiece on the component or screen immediately after inserting it and carry out further steps accordingly. For example, the user can easily define a starting point for the laser, so that after the start of the machining process, the focusing unit is adjusted in such a way that the laser beam impacts on the workpiece at the corresponding position and the machining process is carried out. Alternatively, it is also possible that several jobs or sectional views, respectively, can be positioned and moved on the displayed workpiece so that optimum utilization of the workpiece space is achieved.

Advantageous embodiments are also such in which a so-called fisheye lens is used in the camera, which covers the entire processing chamber. This means that the very large processing chambers of a laser plotter can be captured with a single camera. As a matter of principle, it is possible to use two or more cameras to be able to capture the entire working area, as is done in larger systems. Here, an image merging process is carried out in the background, which creates a single image from the existing images and is displayed accordingly in the software or on the screen, respectively.

Embodiments in which different parameters are stored and loaded for different lenses of the focusing unit for the camera are also advantageous. This makes it possible to automatically adjust the table height or the distance from the camera in order to achieve an optimum display of the workpiece being recorded.

Advantageous embodiments are also such in which, after activation of the calibration process, the laser pointer is activated, or it is checked whether this is already activated, whereupon the focusing unit is adjusted to a predetermined position on the processing table, in particular with a calibration object inserted, whereupon an image of the processing chamber with the laser pointer point is recorded by the camera, whereupon the position, in particular the image coordinates, of the laser pointer point is evaluated and merged with the machine coordinates of the focusing unit and the carriage with the image coordinates. This ensures that very high quality is achieved when displaying the recorded workpiece. Here it is possible that the rectification or image processing process, respectively, can be adapted based on different coordinates, as different data, in particular parameters, can be determined or are stored, respectively, for different coordinates.

Advantageous embodiments are such in which calibration is carried out using the laser pointer with several positions of the focusing unit and carriage. This ensures that better quality is achieved for image processing.

Furthermore, the objective of the present disclosure is achieved by a laser plotter for engraving, marking and/or lettering a workpiece, in which the camera is arranged on the lid of the laser plotter, wherein the position detection is designed to detect the position of the workpiece when the lid is open as well as when the lid is closed, wherein a sensor, in particular a switching element, is arranged for the lid to detect the position of the lid, whereupon a camera correction process can be switched according to the detected lid position or angle, respectively. The advantage here is that the user can view the position of the workpiece on the display at any time, regardless of whether the lid is open or closed. The advantage of detecting the position of the workpiece when the lid is open is that position corrections can be made easily, as the lid does not have to be closed each time to take a picture.

However, the objective of the present disclosure is achieved also by a laser plotter in which the carriage and the focusing unit are positioned at a freely selectable or defined position and the laser pointer is activated to generate a visible laser pointer dot on the image when the calibration process for recording an image of the processing chamber is activated.

The advantage here is that the machine coordinates can be precisely reconciled with the image coordinates. Due to the manual or automatic adjustment of the carriage and the focusing unit, these machine coordinates are known to the control system and transmitted to an external component. The image coordinates are then evaluated by software in the laser plotter or on the external component, in particular the laptop, so that they can be compared with the machine coordinates or merged, respectively, and corrected if necessary. Higher calibration quality can be achieved if several positions are recorded and compared for the calibration process. Preferably, the position adjustment and image acquisition for the calibration process is done fully automatically, so that the user only needs to insert the calibration object, if this is necessary due to the processing table, whereupon the calibration process is started by him/her and the adjustment or positioning, respectively, of the carriage and focusing unit takes place automatically, whereby the laser pointer is activated at least during image acquisition in order to be able to subsequently evaluate the laser pointer point using software, i.e. that the image coordinates correspond to the laser pointer point. If the laser pointer is not coupled directly into the laser beam path, but runs separately, or if the laser pointer is arranged directly on the focusing unit, a corresponding correction value can be stored so that the machine coordinates that define the laser beam match the image coordinates of the laser pointer point.

Finally, an embodiment in which the camera is equipped with a so-called fisheye lens is advantageous. This allows a very large processing chamber to be covered with one camera, so that only one camera is required for smaller devices. For larger systems or devices, respectively, it is possible to use several cameras to cover the entire processing chamber.

The present disclosure is now described in the form of an exemplary embodiment, whereby it is emphasized that the present disclosure is not limited to the exemplary embodiment or solution shown and described, but can be applied to equivalent solutions.

### BRIEF DESCRIPTION OF THE DRAWINGS

FIG. 1 is a schematic illustration of a laser device, in particular a laser plotter, for processing a workpiece with a camera system on the closed lid—simplified, for illustrative purposes only.

FIG. 2 is a schematic illustration of the laser device, in particular the laser plotter, according to FIG. 1 for processing a workpiece with a camera system on the open lid—simplified, for illustrative purposes only.

FIG. 3 is a schematic sectional view of the laser device with lid open and calibration plate inserted—simplified, for illustrative purposes only.

FIG. 4 is a schematic sectional view of the laser device with lid closed and calibration plate inserted—simplified, for illustrative purposes only.

FIG. 5 is a schematic illustration of a further laser device, in particular a laser plotter, with an open lid, in which two cameras are integrated in the camera system—simplified, for illustrative purposes only.

FIG. 6 is a schematic illustration of the laser device as shown in FIG. 5 with the lid closed.

FIG. 7 is a schematic illustration of a laser plotter with an inserted calibration object and activated laser pointer with the lid closed—simplified, for illustrative purposes only.

FIG. 8 is a schematic illustration of the laser plotter with inserted calibration object and activated laser pointer with the lid open—simplified, for illustrative purposes only.

By way of introduction, it should be noted that in the various embodiments, identical parts are provided with identical reference signs or identical component designations, respectively, and the disclosures contained in the entire description can be applied mutatis mutandis to identical parts with identical reference signs or identical component designations, respectively. The positional information selected in the description, such as top, bottom, side, etc., likewise refers to the figure described and is to be transferred to the new position mutatis mutandis in the event of a change of position.

### DETAILED DESCRIPTION OF EMBODIMENTS

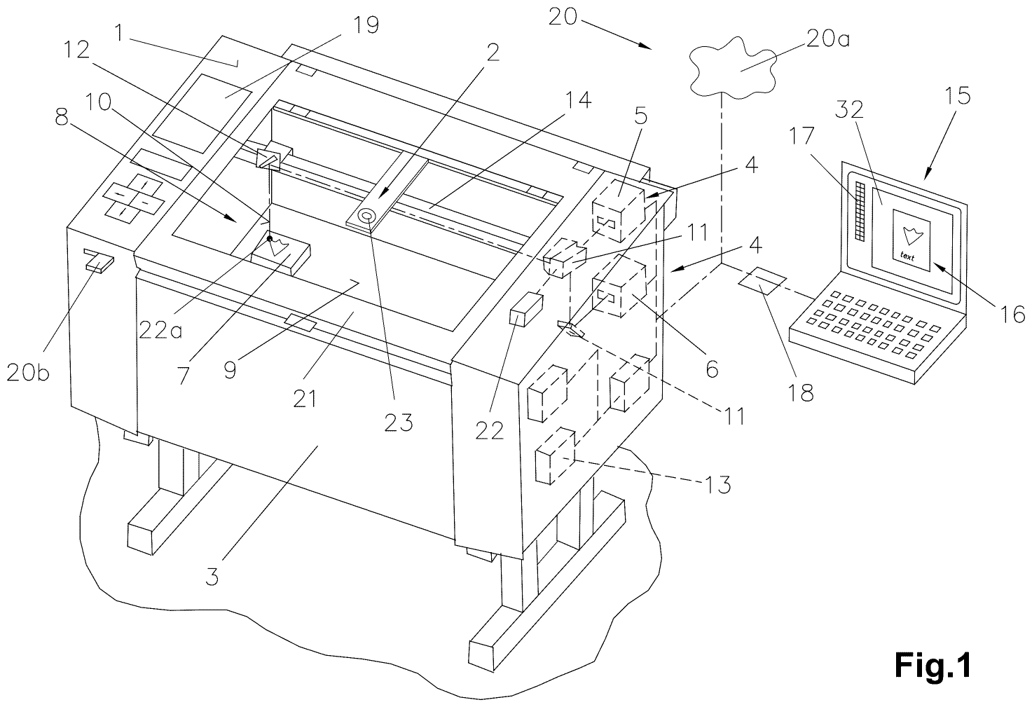

FIGS. 1 to 8 show an example of a laser device 1, in particular a laser plotter 1, into which a camera system 2 is integrated.

In the laser plotter 1 shown in FIG. 1, at least one, preferably two, beam sources 4 or laser sources 4, respectively, in the form of lasers 5, 6 are arranged in a housing 3. The lasers 5 and 6 preferably act in alternating fashion on a workpiece 7 to be processed. The workpiece 7 is positioned in a processing chamber 8 of the laser plotter 1, in particular on a processing table 9, whereby the processing table 9 is preferably height-adjustable. A laser beam 10 emitted by an irradiation source 4, in particular the laser 5 or 6, is sent via deflection elements 11 to at least one movable focusing unit 12, from which the laser beam 10 is deflected in the direction of the workpiece 7 and focused for processing. Control, in particular the position control of the laser beam 10 in relation to the workpiece 7, is carried out via software running in a control unit 13, whereby the workpiece 7 is processed by adjusting a carriage 14, on which the focusing unit 12 is also movably arranged, preferably via a belt drive in X-Y direction. Here it is possible, for example, that in the “engraving” machining process, the carriage 14 is moved line by line, whereas in the “cutting” machining process, the carriage 14 is moved according to the contour to be cut, i.e. not line by line.

On an external component 15, in particular a computer or a control unit, a graphic 16 and/or a text 16 is created or loaded, respectively, using a commercially available software 17, such as CorelDraw, Paint, etc., or proprietary application software 17, in particular Ruby®, which is exported or transferred, respectively, to the controller 13 of the laser device 1 in the form of a job 18a. Preferably, the data to be transferred are converted by the same or a different software so that the controller 13 can process the job 18. Of course, it is also possible for the input to be made directly on the laser plotter 1 using the available input means 19, such as a touchscreen 19 or input buttons, or for a corresponding job 18 to be loaded from a storage medium 20, such as a cloud 20a, a USB stick 20b, etc. After the data, in particular the job or jobs 18, have been transferred or created directly or loaded from the storage medium 20, the laser device 1, in particular its control unit 13, processes the job 18. Here it is possible for several jobs 18 to be stored simultaneously in the laser device 1, in particular the laser plotter 1, and processed sequentially.

With laser devices 1 of this type, it is necessary for safety reasons that a lid 21 or door 21, which is preferably at least partially transparent, must be closed to start a job 18 to be processed in which the laser beam 10 acts on the workpiece 7, as shown in FIGS. 1, 4 and 6. The operating staff can then manually or automatically position the laser dot or a laser pointer 22, in particular laser pointer dot 22a, which is coupled into the beam path of the laser 5, 6 and is deflected in the direction of the processing table 8 via the focusing unit 12, on the inserted workpiece 7, whereupon the job 18 for processing the workpiece 7 can be started. At the end of the job 18, the carriage 14 is then preferably moved to the starting position so that the finished workpiece 7 can be removed, whereupon a new machining process can be started by inserting a new workpiece 7 or blank 7, respectively, to be machined. It is advantageous if the end of processing is indicated visually or acoustically so that the user does not have to constantly monitor the laser device 1. For the sake of completeness, it is mentioned that the focusing unit 12 can also be adjusted with the laser pointer 22 activated when the lid 17 is open, but the laser 5, 6 cannot be activated.

In the novel laser plotter 1 or laser device 1, it is now envisaged that the laser device 1 or laser plotter 1 performs a method for determining a position of a workpiece 7 in the processing chamber 8 of the laser plotter 1 for cutting, engraving, marking and/or lettering the workpiece 7 by means of the camera system 2, or the laser plotter 1 is designed for this purpose.

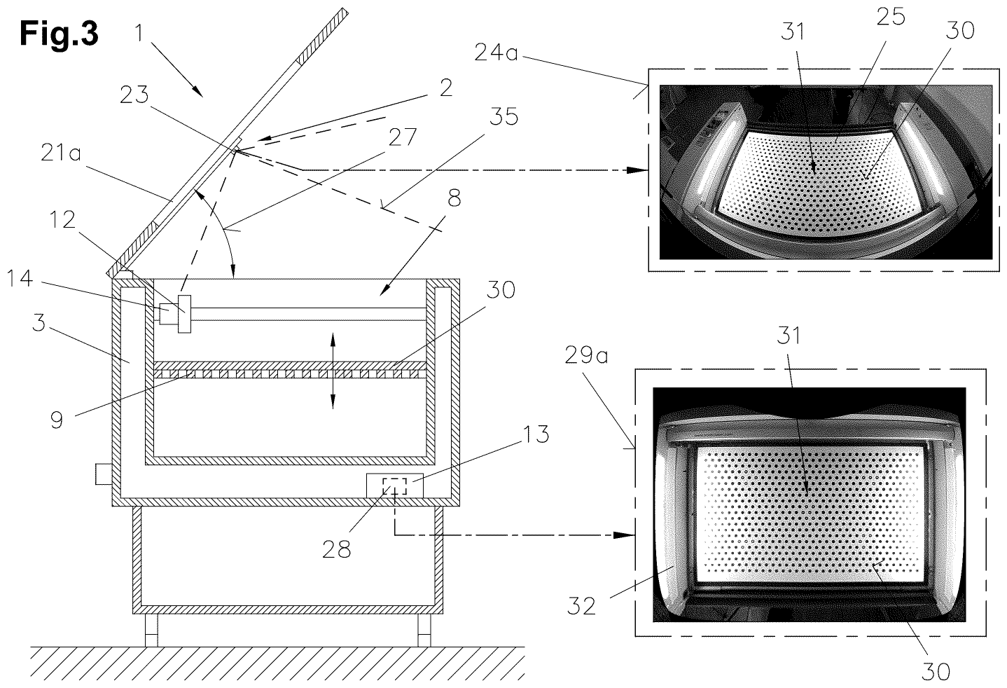

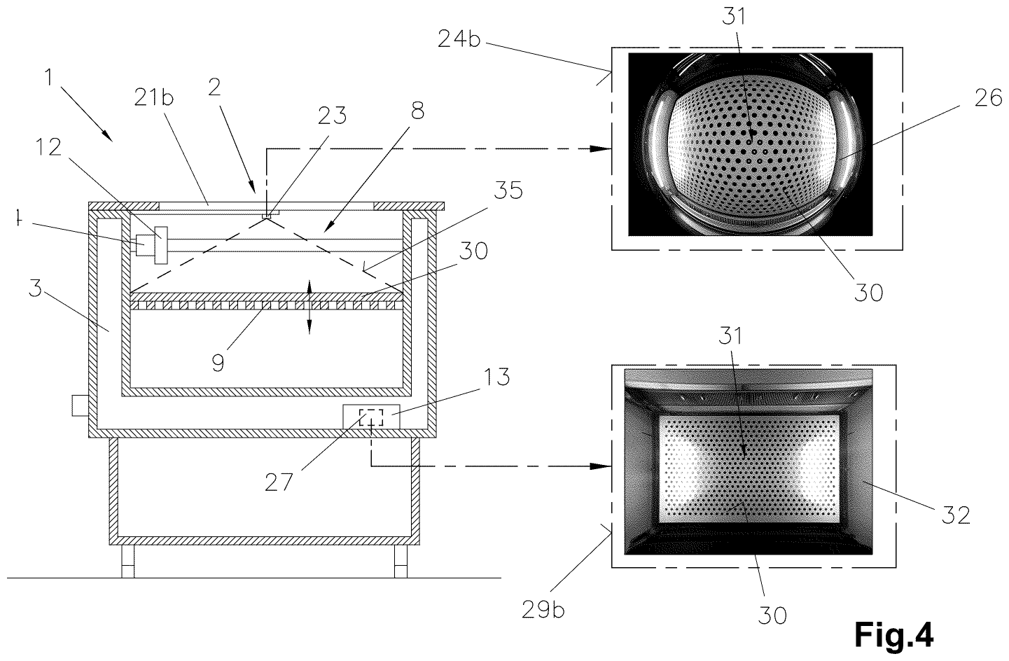

For this purpose, the camera system 2 has at least one camera 23 with a preferably interchangeable lens (not shown), wherein the camera 23 preferably has a fisheye lens 24, as illustrated by a captured image 25 and 26 according to FIGS. 3 and 4. Use of a fisheye lens 24, makes it possible to record or cover, respectively, a very large processing chamber 8 with just one camera 23. Of course, it is also possible to use normal optics to record the processing chamber 8 of the laser plotter 1.

As already explained in the introduction to the description, laser devices 1 or laser plotters 1, respectively, are equipped with such camera systems 2, which enable an image to be captured either when the lid 21 is open or closed.

According to the disclosed embodiments, it is now envisioned that at least one camera 23 for the processing area 8 is integrated in the lid 21 of the laser plotter 1, whereby the detection of the position of the inserted workpiece 7 is carried out both when the lid 21 (21a, 21b) is open and when it is closed by automatically detecting the position, in particular the opening angle 27, of the lid 21, whereupon a corresponding camera correction process 28, as schematically indicated in the control 13 of the laser device 1, is activated for the open or closed lid 21.

For a corresponding camera correction process 28 to be carried out, a calibration process 29a with the lid 21a open and a calibration process 29b with the lid 21b closed must be carried out for the camera correction process 28 when the laser plotter 1 is commissioned for the first time, as shown in FIGS. 3 and 4. To this end, a calibration object 30 with calibration symbols 31 arranged on it is placed on the processing table 9. Subsequently, an image 25, 26 is captured by the camera 23, whereupon the calibration process performs a rectification of the captured image 25 or 26, as shown in FIGS. 32, 33, i.e. in each case a calibration process 29a, 29b is carried out with the lid open 21a and the lid closed 21b in order to achieve a rectification of the fisheye optics 24a, 24b, so that the user is shown a rectified and sharply contoured image 32, 33 on the display or the external component 15 whenever a workpiece 7 is inserted into the machining area. For the sake of completeness, it is mentioned that the calibration parameters resulting from the calibration process are stored so that they can be used by the camera correction process 28 to recognize one or more inserted workpieces 7, whereby the camera correction process 28 automatically uses the corresponding application depending on the position of the lid 21, i.e. open lid 21a or closed lid 21b. It can thus be said that the camera correction process 28 is switched over or adapted as a function of the opening angle 27 of the lid 21, i.e. that for preferably defined positions of the lid 21, a camera correction process 28 correspondingly assigned to this position is used by the control unit 13. Here, certain position ranges or opening angle ranges, respectively, can be defined in which a specific camera correction process 28 is carried out. It is therefore possible that at least two or more different camera correction processes 28 are used. For the sake of completeness, it is mentioned that several correction processes 29 can also be carried out for different positions of the lid 21, or that the software can be used to adapt the correction process 29 for between two positions, in particular fully closed and open, of the lid 21.

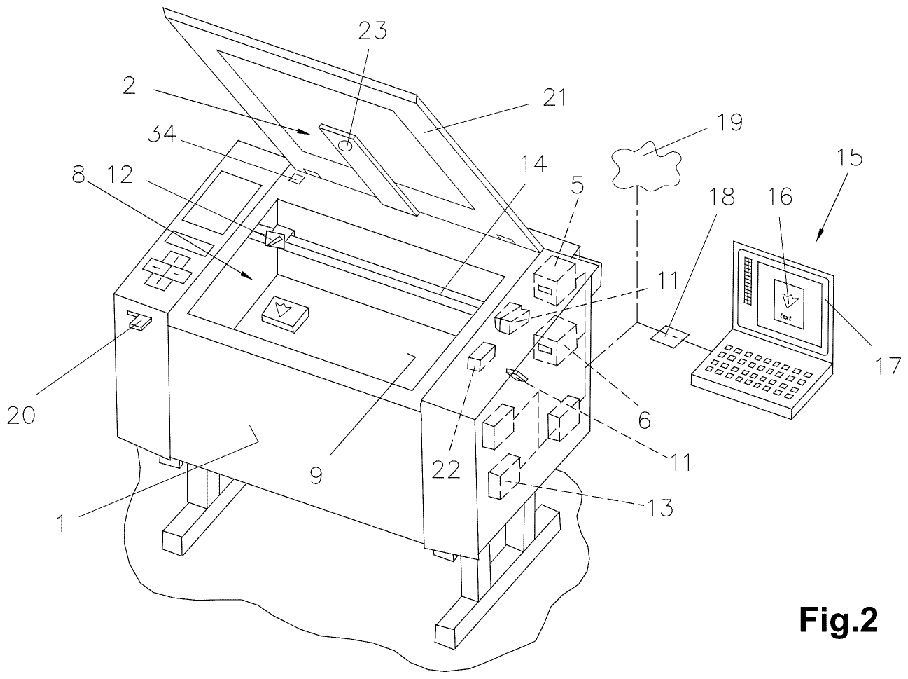

Preferably, the camera system 2 is automatically activated when the lid 21 is opened, whereby this remains active until the camera system 2 is manually ended or the processing process, in particular the laser 5, 6, is started. Although it is possible for camera system 2 to remain activated during processing, it is recommended not to activate this manually adjustable and storable option due to the smoke produced. The opening or closing of the lid 21 is detected by a switching element 34 (FIG. 2), whereby the information is forwarded from the switching element 34 to the control unit 13 so that it can select the corresponding camera correction process 28. It is possible for any opening angle 27 to be detected and forwarded, or for only certain positions of the lid 21, such as open or closed, to be forwarded to the control unit 13. As a result, the controller 13 or the camera correction process 28 preferably running in the controller 13 can select the correspondingly required correction process 29a, 29b for the position of the lid 21a or 21b and process the captured image 25 or 26 accordingly, in particular rectify it, in order to display a corrected image 32, 33.

Due to the possibility according to the disclosed embodiments of the camera system 2 capturing images with the lid 21a open as well as with the lid 21b closed, it is necessary on the one hand to detect the position of the lid 21 and on the other hand to carry out a correction process 29 applied accordingly to the position of the lid 21, since the viewing range 35 of the camera 23, as shown with dotted lines in FIGS. 3 and 4, is aligned very differently. It is essential that the user is shown a very high-resolution image 32, 33 of an inserted workpiece 7 on the display or the external component 15 in order to be able to precisely position the laser 5, 6, in particular the laser pointer 22 or laser pointer point 22a, respectively.

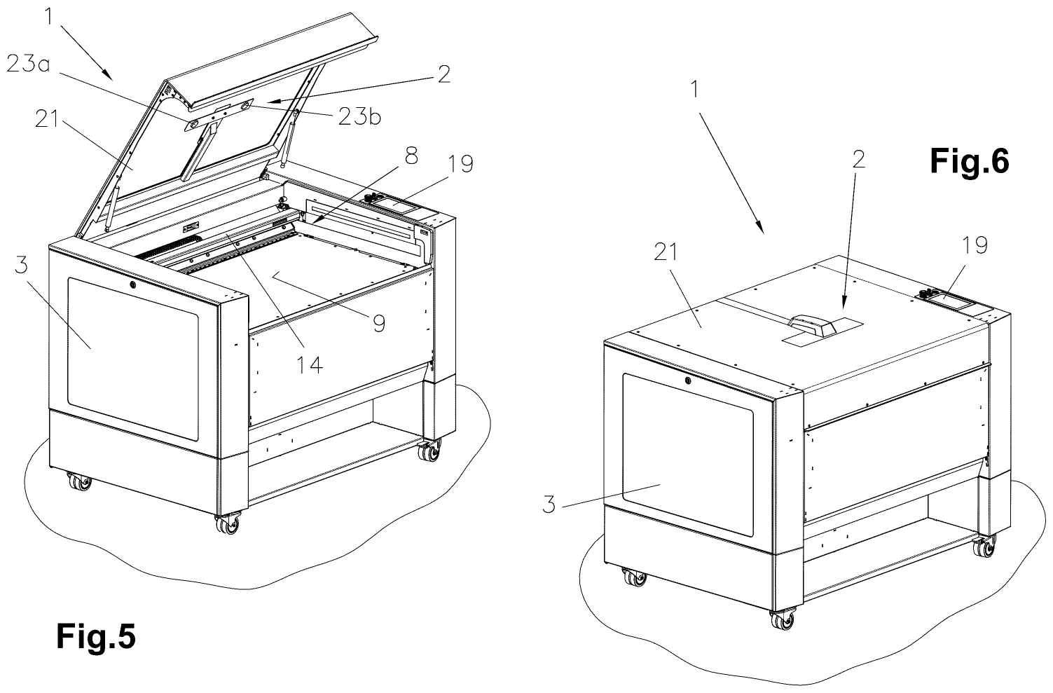

As can also be seen from FIGS. 5 and 6, it is possible for several cameras 23a, 23b to be used in the camera system 2 of the laser device 1, for example in order to be able to capture the processing chamber 8 of a very large system or laser device 1, respectively. Here it is possible that several cameras 23a, 23b are used in one camera system 2, or that a separate camera system 2 is used for each camera 23a, 23b installed. When multiple cameras 23a, 23b are used, the individual images from each camera 23a, 23b are captured and then stitched together via the camera correction process 28 to form a single image 32, 33, with rectification of the individual images also performed in between.

As a matter of principle, it should be mentioned that when an external component 15, in particular a laptop, is connected, the image recording and forwarding from the laser plotter 1 to the external component 15 takes place in real time, i.e. when a workpiece 7 is inserted into the processing area 8, this can be observed directly on the external component 15, as the data from the camera 23 are forwarded directly to the external component 15 via the interface. This makes it possible also to design a laser plotter 1 in which the calibration process 29 and/or the camera correction process 29 is carried out in the external component 15, in particular via the running software, since the recorded image 25, 26 is sent directly to the external component 15, whereby the position or angle, respectively, of the lid 21 is also transmitted. For the sake of completeness, it is mentioned that the camera correction process 28 as well as the calibration process 29 can run on both devices, i.e. on the laser plotter 1 and the external component 15.

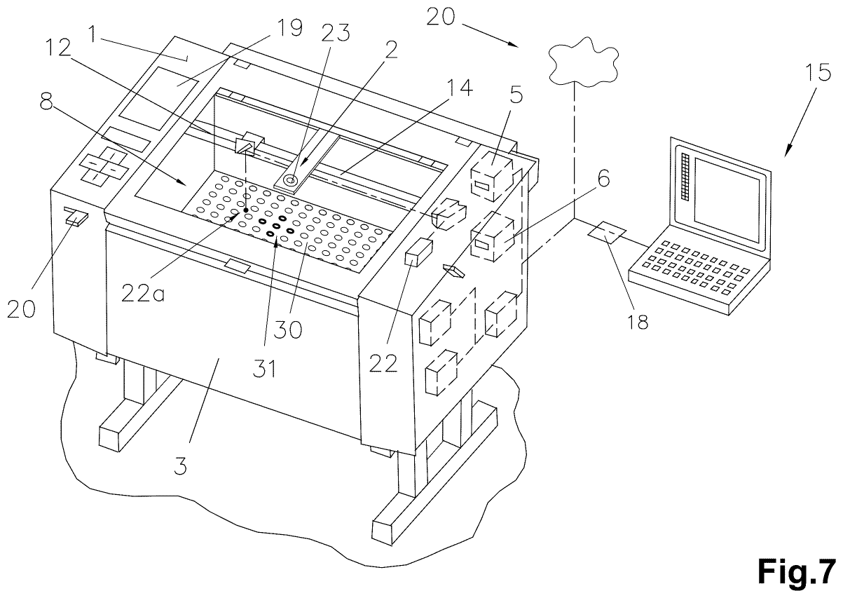

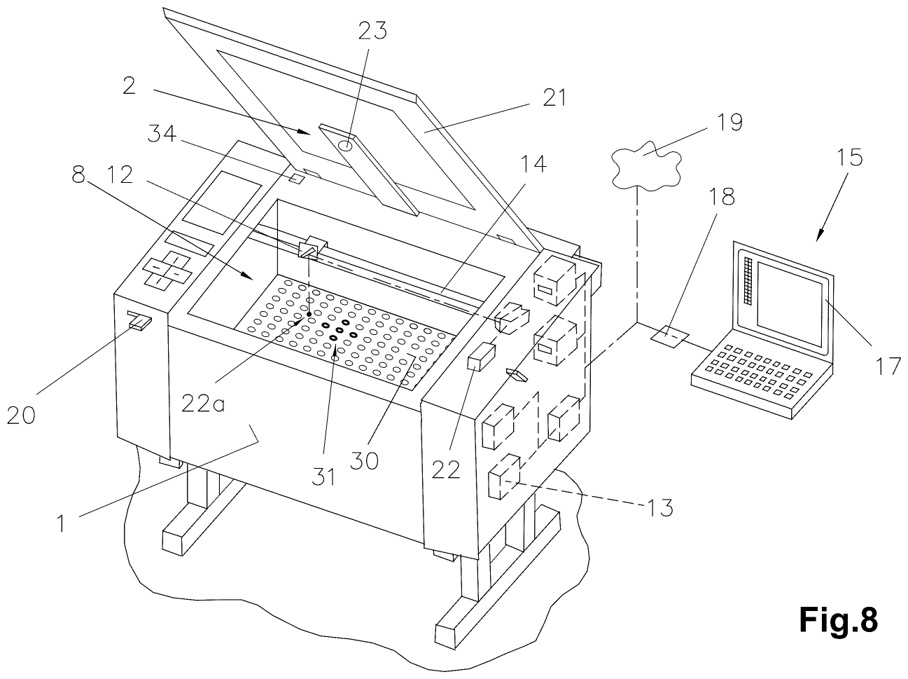

Furthermore, FIGS. 7 and 8 describe a calibration method according to the present disclosure, in which the calibration process is carried out with the aid of the laser pointer 22 or laser pointer point 22a, respectively, and an inserted calibration object 30. The calibration process must again be carried out with the lid 21 closed and open, whereby this can be carried out manually or automatically.

A calibration object 30 must first be placed in the processing chamber 8, in particular on the processing table 9, in order to be able to visibly position the laser pointer 22, in particular laser pointer point 22a. Of course, it is also possible for the processing table 9 to be designed in such a way that the laser pointer point 22 is visible on the processing table 9 when the laser pointer 22 is activated. This is necessary because an image of the machining area is taken for the calibration process, whereby the position of the laser pointer point 22a is then evaluated by an evaluation software and these image coordinates are compared with the machine coordinates of the focus unit 12 and the carriage 14 in order to be able to carry out a precise rectification.

Preferably, the calibration process is carried out automatically, for which purpose the calibration process is started on the external component 15 or directly on the laser device 1 after the calibration object 30 has been inserted; the carriage 14 and the focusing unit 12 are then adjusted to one or more positions, for which purpose the laser pointer 22 is activated and the laser pointer beam is coupled in, so that the laser pointer point 22a is visible on the inserted calibration object 30. If the carriage 14 and the focusing unit 12 have been moved to the defined position, these machine coordinates are recorded and preferably stored if they are not already stored. An image of the processing chamber 8 is then captured by the camera 23, and the laser pointer point 22a visible in the image is evaluated by software so that corresponding image coordinates are determined; these are then merged with the machine coordinates so that corresponding parameters for the calibration process can be determined and stored. These parameters are then used by the camera correction process 28 to process a captured image 25, 26 so that the user can always view a nice representation of the inserted and recorded workpiece 7.

For the sake of completeness, it is pointed out that several positions are approached for the calibration process in order to obtain several comparison data, which improves the quality of the image processing. Here it is advantageous that those positions are used for the image recording where the laser pointer point 22a is clearly visible on the recorded image, so that reliable evaluation and determination of the image coordinates is achieved; here it is not essential whether the laser pointer point 22a is or will be positioned on any specific calibration symbol 31, but that the laser pointer point 22a is clearly visible to the camera 23.

This also enables manual adjustment of the laser pointer point 22a, since the manual adjustment of the carriage 14 and the focusing unit 12 means that the machine coordinates are known on the one hand, whereupon the image coordinates are evaluated by recording an image 25, 26 by the camera 23, so that the machine coordinates and the image coordinates can be combined. When using calibration objects 30, black dots are often arranged, so that it is advantageous that the laser pointer 22 or the laser pointer dot 22a is positioned on areas or locations, respectively, on the calibration object 30 that are easily visible, in particular in the areas between the black dots.

Another optional function on the laser plotter 1 is that the lid 21 can be opened and closed manually or automatically. This makes it possible for the calibration process to carry out an automatic adjustment of the carriage 14 and the focusing unit 12 for the machine coordinates and an image acquisition to determine the image coordinates, regardless of the position of the lid 21, i.e. whether it is closed or open, by preferably first carrying out the calibration process with the currently existing position of the lid 21 and then automatically opening or closing the lid 21, whereupon the calibration process is carried out again. This ensures that the calibration process is always carried out with the lid 21 open and closed.

It can therefore be said that when the calibration process for capturing an image 25, 26 of the processing chamber 8 is activated, the carriage 14 and the focusing unit 12 are positioned at a freely selectable or defined position and the laser pointer 22 is activated to generate a visible laser pointer dot 22a on the image 25, 26. It is advantageous if several different positions for the calibration process are approached, preferably automatically, and an image 25, 26 with activated laser pointer 22 is recorded at each position so that the photographed or recorded, respectively, laser pointer point 22a can be evaluated for the generation of the image coordinates. Here it is also possible that corresponding calibration positions for the laser pointer point, in which the laser pointer point 22a is clearly visible with a preferably bright background, are marked on the calibration object 30 so that manual adjustment is also possible.

As a matter of principle, it should be mentioned that the laser plotter has a distance measuring device so that the table height is automatically adjusted. This is advantageous because the calibration or rectification, respectively, of the recorded image 25, 26 is best coordinated with a defined distance from the camera 23 to the surface of the calibration object 30 and thus also to the surface of the workpiece 7, i.e. that the distance to the surface of the workpiece 7 is always measured for workpieces 7 of different thicknesses and the processing table 9 adjusted accordingly in order to always obtain approximately the same distance to the camera 23.

For the sake of completeness, it is pointed out that all processes can be carried out directly in the laser plotter 1 or also via the external component 15, in particular a connected laptop, i.e. that, for example, the calibration process is started by the external component 15 and the software processing of the recorded images 25, 26 is also carried out on the external component 15. Of course, it is also possible to do this via the cloud 20a.

In the present disclosure, the camera system 2 is understood to be the mounting or holder, respectively, for the camera 23 and the lines running therein to the corresponding internal components, in particular the control unit 13.

As a matter of principle, the laser plotter 1 illustrated shows laser beam guidance via deflection elements 11 from a laser source 4, in particular laser 5, 6, to the focusing unit 12, although the deflection elements 11 can be replaced by an optical waveguide, i.e. the deflection elements 11 are formed by an optical waveguide which guides the laser beam 10 generated by the laser 5, 6 to the focusing unit 12. It is also possible that a wide variety of types can be used as the beam source 4, in particular lasers 5, 6, which can also be positioned directly on the focusing unit 12, i.e. that, for example, when using a diode laser, this is arranged directly on the focusing unit 12 and the laser beam 10 generated is directed into the processing chamber 8, in particular in the direction of the processing table 9.

For the record, it should be noted that the present disclosure is not limited to the embodiments shown, but may also include other designs and structures.

1. A method for determining a position of a workpiece in a processing chamber of a laser plotter for cutting, engraving, marking and/or lettering the workpiece, in which at least one beam source in the form of a laser is used in a housing of the laser plotter, whereby the workpiece is deposited on a processing table and the position of at least one inserted workpiece on the processing table or in the processing chamber detected by at least one camera, whereby for processing the workpiece a laser beam emitted by the beam source is sent via deflecting elements to at least one focusing unit, from which the laser beam is deflected in the direction of the workpiece and focused for processing, wherein the control is performed via software running in a control unit, wherein the workpiece is processed by adjusting a carriage via a belt drive in X-Y direction, wherein a graphic and/or a text is generated on an external component, which is transferred or exported to the control unit of the laser plotter, which performs a conversion of the transferred data, for controlling the individual elements of the laser device, wherein at least one camera for the processing chamber is integrated into a lid of the laser plotter, whereby detection of the position of the inserted workpiece for the processing chamber, such as the ruler, is performed both when the lid is open and when it is closed, wherein automatic detection of the position is performed, whereupon a corresponding camera correction process is activated for the open or closed lid.

2. (canceled)

3. The method according to claim 1, wherein a calibration process for the camera correction process is carried out with the lid open and closed at least during an initial commissioning of the laser plotter, and wherein a calibration object with calibration symbols arranged thereon is inserted on the processing table.

4. The method according to claim 1, wherein the opening and closing of the lid is detected via a switching element which sends a corresponding signal to the control unit of the laser plotter.

5. The method according to claim 1, wherein the position of the workpiece is displayed directly on a connected external component.

6. The method according to claim 1, wherein a lens is used in the camera, which lens covers the entire processing chamber.

7. The method according to claim 1, wherein the detection of the position of one or several inserted workpieces is, respectively, triggered manually via the external component or an actuating element or touchscreen, respectively, on the laser plotter.

8. The method according to claim 1, wherein after the position detection of the workpiece for processing the workpiece, the focusing unit is positioned manually or automatically according to the workpiece shown.

9. The method according to claim 1, wherein different calibration parameters are stored and loaded for different lenses of the focusing unit for the camera.

10. The method according to claim 1, wherein, after activation of the calibration process, the laser pointer is activated, or it is checked whether this is already activated, whereupon the focusing unit is adjusted to a predetermined position on the processing table, whereupon an image of the processing chamber with the laser pointer point is recorded by the camera, whereupon the position of the laser pointer point is evaluated and merged with machine coordinates of the focusing unit and the carriage with image coordinates.

11. The method according to claim 1, wherein calibration is carried out with the aid of the laser pointer with several positions of the focusing unit and carriage.

12. A laser plotter for engraving, marking, and/or lettering a workpiece, comprising a processing chamber for positioning a workpiece, at least one beam source in the form of lasers with corresponding deflecting elements and a movable focusing unit and a control unit for controlling a carriage operated via a belt drive with a focusing unit arranged movably thereon, wherein for determining the position of the workpiece in the processing chamber or on a processing table at least one camera system with a camera is arranged on the processing table, wherein the camera is arranged on the lid of the laser plotter, whereby the position detection is designed to detect the position of the workpiece when the lid is open as well as when it is closed, whereby a sensor for the lid is arranged to detect the position of the lid, whereupon, in accordance with the detected lid position or lid angle, respectively, a camera correction process can be switched according to the detected lid position or lid angle, respectively.

13. The laser plotter according claim 12, wherein when the calibration process for recording an image of the processing chamber is activated, the carriage and the focusing unit are positioned at a freely selectable or defined position and the laser pointer is activated to generate a visible laser pointer point on the image.

14. (canceled)

15. The laser plotter according to claim 12, wherein the camera is equipped with a so-called fisheye lens.

16. (canceled)

17. A method for calibrating a relationship between image coordinates and machine coordinates of a laser plotter for cutting, engraving, marking, and/or lettering a workpiece, in which at least one beam source in the form of a laser is used in a housing of the laser plotter, whereby the workpiece is placed on a processing table and a position of at least one inserted workpiece on the processing table or in a processing chamber detected via at least one camera, wherein, for the calibration process, an image is taken by the camera of the processing chamber with activated laser pointer, wherein the image coordinates of the laser pointer are determined via an evaluation software.

18. The method according to claim 17, wherein the activated laser pointer includes a visible laser pointer point, and wherein the image coordinates of the visible laser pointer point are determined via the evaluation software.

19. The method according to claim 17, wherein the calibration process for the camera correction process is carried out with the lid open and closed at least during an initial commissioning of the laser plotter, and wherein a calibration object with calibration symbols arranged thereon is inserted on the processing table.

20. The method according to claim 17, wherein the opening and closing of the lid is detected via a switching element which sends a corresponding signal to a control unit of the laser plotter.

21. The method according to claim 17, wherein the position of the workpiece is displayed directly on a connected external component.

22. The method according to claim 17, wherein a lens is used in the camera, which lens covers the entire processing chamber.
